(19) United States
(12) Patent Application Publication
(10) Pub. No.: US 2009/0176140 A1
(43) Pub. Date: Jul. 9, 2009

(54) FUEL CELL PROVIDING IMPROVED DISPOSING STRUCTURE FOR UNIT CELLS

(75) Inventors: Lei HU, Yongin-si (KR); Jae-yong Lee, Yongin-si (KR); Kyoung-hwan Choi, Yongin-si (KR); Jin-ho Kim, Yongin-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/135,416

(22) Filed: Jun. 9, 2008

(30) Foreign Application Priority Data
Jan. 8, 2008 (KR) 2008-2337

(51) Int. Cl. H01M 8/10; H01M 8/02

(52) U.S. Cl. 429/30; 429/34

(57) ABSTRACT

A fuel cell including a plurality of unit cells that each includes an anode, an electrolyte membrane, and a cathode. The unit cells are stacked together, such that the unit cells form rows and furrows. The fuel cell can further include an anode frame to support an anode side of the fuel cell stack, and a cathode frame to support a cathode side of the fuel cell stack. The fuel cell can include reinforcing members to support either of the frames.

### CROSS-REFERENCE TO RELATED APPLICATIONS

This application claims the benefit of Korean Patent Application No. 2008-2337, filed on Jan. 8, 2008, in the Korean Intellectual Property Office, the disclosure of which is incorporated herein in its entirety by reference.

### BACKGROUND OF THE INVENTION

1. Field of the Invention

Aspects of the present invention relate to a fuel cell having a plurality of unit cells to generate electricity.

2. Description of the Related Art

A fuel cell is an electric generator that changes chemical energy of a fuel into electrical energy, through a chemical reaction, and can continuously generate electricity as long as the fuel is supplied.

A fuel cell includes a plurality of unit cells, where the electricity generation reaction is conducted. In each of the unit cells, an anode, an electrolyte membrane, and a cathode are sequentially stacked. Thus, when a fuel is supplied to the anodes and an oxidant source (oxygen from air) is supplied to the cathodes, electricity is generated in each of the unit cells, by a reverse water hydrolysis reaction.

If the unit cells are well arranged, the structure of the fuel cell can be efficiently compacted. Thus, research is being actively conducted into the structure of a fuel cell.

### SUMMARY OF THE INVENTION

Aspects of the present invention provide a fuel cell, in which the structure of unit cells is improved.

According to an aspect of the present invention, there is provided a fuel cell including a plurality of unit cells disposed at an angle of 0° to 180°, with respect to adjacent unit cells. Each unit cell includes an anode, an electrolyte membrane, and a cathode stacked therein.

According to an aspect of the present invention, the unit cells may be disposed in a zigzag pattern, at substantially the same angle.

According to an aspect of the present invention, the fuel cell may further comprise: an anode frame that supports an anode side of the unit cells; a cathode frame that supports a cathode side of the unit cells; a housing that surround a lower part of the anode frame; and a fuel supply unit to supply a fuel to the anode, through a space defined in the housing.

According to an aspect of the present invention, the fuel supply unit may comprise: a fuel storage tank where the fuel is stored; and a transportation tube unit to transport the fuel from the fuel storage tank to the space defined in the housing.

According to an aspect of the present invention, the transportation tube unit may be formed through the housing, or the anode frame, and the fuel supply unit may further comprise actuators that selectively open and close flow channels of the transportation tube unit.

According to an aspect of the present invention, at least one of the anode frame and the cathode frame may comprise reinforcing members to increase the strength of the anode frame, or the cathode frame. The fuel cell may further comprise end plates on ends of the anode frame, to block the infiltration of air into the fuel cell.

According to an aspect of the present invention, the unit cells are formed as one body, which may be folded to have an angle of 0° to 180°, between the unit cells. The unit cells may also be separately formed, and disposed at angles with respect to each other.

According to an aspect of the present invention, the unit cells may be connected by plane units.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings of which:

FIGS. 1A and 1B are respectively an exploded perspective view and a perspective view of a structure of a fuel cell, according to an exemplary embodiment of the present invention;

FIG. 2 is a perspective view of a modified version of a fuel supply unit, of the fuel cell of FIGS. 1A and 1B, according to an exemplary embodiment of the present invention;

FIGS. 3A through 3C are perspective views of modified versions of a frame of the fuel cell of FIGS. 1A and 1B, according to an exemplary embodiment of the present invention;

FIGS. 4A through 4C are perspective views of modified versions of the unit cells, of the fuel cell of FIGS. 1A and 1B, according to an exemplary embodiment of the present invention; and

FIGS. 5A through 5C are cross-sectional views of modified versions of the unit cells, of the fuel cell of FIGS. 1A and 1B, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

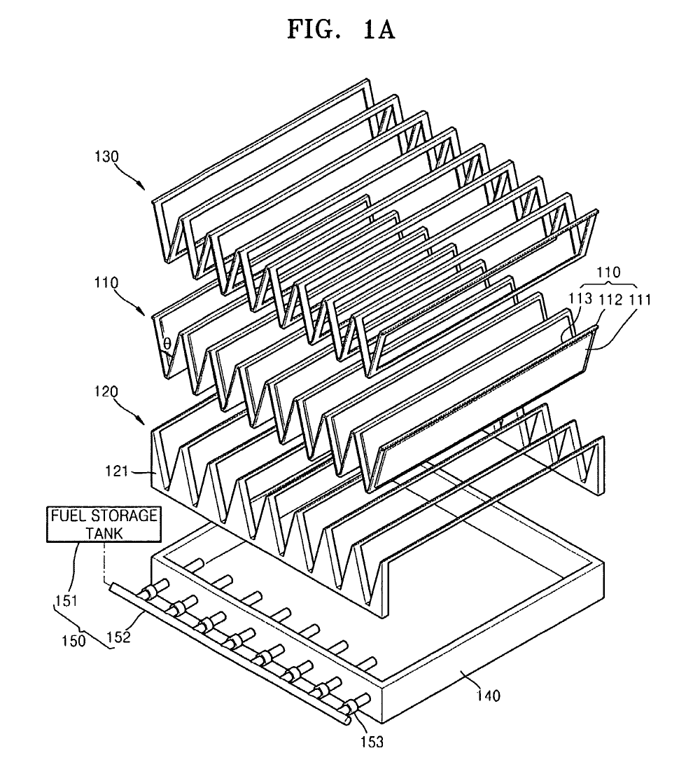

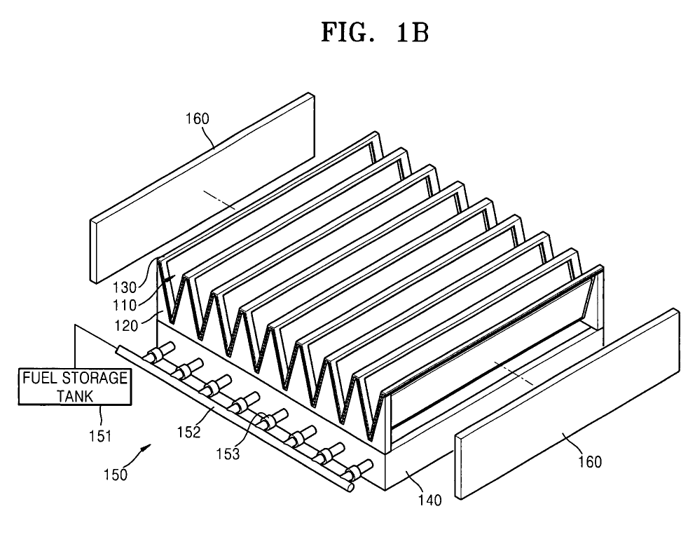

FIGS. 1A and 1B are respectively an exploded perspective view and a perspective view of a structure of a fuel cell, according to an exemplary embodiment of the present invention. Referring to FIGS. 1A and 1B, the fuel cell includes: a plurality of unit cells 110, in which an anode 111, an electrolyte membrane 112, and a cathode 113 are stacked; an anode frame 120 that supports the anode 111 of the unit cells 110; a cathode frame 130 that supports the cathodes 113; and a housing 140 that defines a space (fuel space) to supply a fuel to the anode 111, and which surrounds a lower part of the anode frame 120.

The unit cells 110 are connected to one another, so as to have an angle θ of between 0° to 180°, in a zigzag pattern. For example, the unit cells 110 can resemble a folding screen or a pleated fan, rather than have multiple layers, or a plane disposition. For example, the unit cells can be disposed in a stack having rows and furrows formed by the unit cells. The anode frame 120 and the cathode frame 130 are also formed in the same pattern as the unit cells 110, to support the unit cells 110.

The fuel cell also includes a fuel supply unit 150 to supply a fuel to the anodes 111 of the unit cells 110, through the space of the housing 140, which is disposed at a lower side of the anode frame 120. The fuel supply unit 150 includes a fuel storage tank 151, where the fuel is stored, and a transportation tube unit 152 to transport the fuel of the fuel storage tank 151, to the space defined by the housing 140. The fuel can be a hydrocarbon group fuel, such as, methanol or ethanol, which vaporizes at room temperature. The fuel that has entered the space of the housing 140, from the fuel storage tank 151 and along the transportation tube unit 152, vaporizes before being supplied to the anodes 111 of the unit cells 110. Actuators 153 are installed on the transportation tube unit 152, to control the amount of injected fuel of flow channels of the transportation tube unit 152. When the fuel of the fuel storage tank 151 enters the space of the housing 140, along the transportation tube unit 152, due to the opening the transportation tube unit 152 by the actuators 153, the fuel vaporizes in the space. Electricity is generated through an electricity generation reaction, between the vaporized fuel supplied to the anodes 111 of the unit cells 110, and oxygen in the air supplied to the cathodes 113. In FIG. 1B indicates end plates 160 cover openings formed in both ends of the anode frame 120 and the cathode frame 130.

According to the structure described above, the fuel cell can include any number of the unit cells 110. That is, if the unit cells 110 are disposed in a zigzag pattern, with an appropriate angle θ, i.e., not simply disposed in a plane, or parallel to each other, a greater number of the unit cells 110 can be disposed in the same space. Thus, the fuel cell can generate an increased amount of electricity, since the unit cells 110 are compactly disposed. Also, if the unit cells 110 are disposed in a multi-layer structure, a complicated fuel supply system must be included. However, in the present structure, the fuel is simply supplied in the space below the anodes 111, thereby significantly simplifying the fuel cell structure.

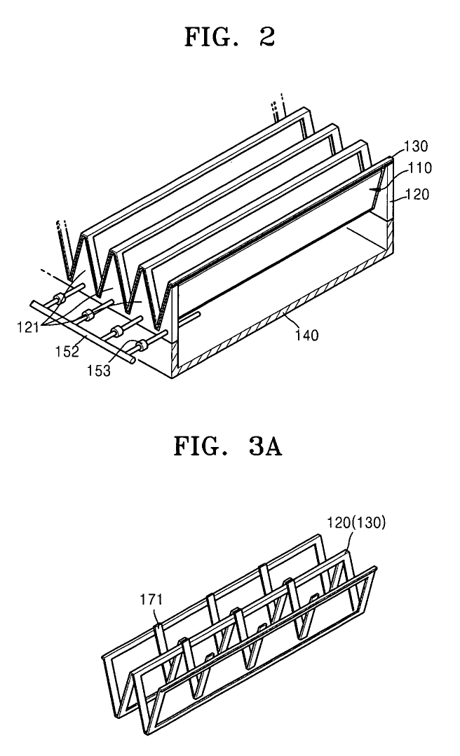

Various modifications can be made to the basic structure shown in FIGS. 1A and 1B. For example, in FIGS. 1A and 1B, the transportation tube unit 152 of the fuel supply unit 150 passes through the housing 140. However, as depicted in FIG. 2, the transportation tube unit 152 can be installed to pass through a blocking wall 121. The blocking wall 121 prevents the fuel from leaking through sides of the fuel cell. Thus, the transportation tube unit 152 can extend through the blocking wall 121, to supply a fuel to a lower side of the anodes 111, to be vaporized.

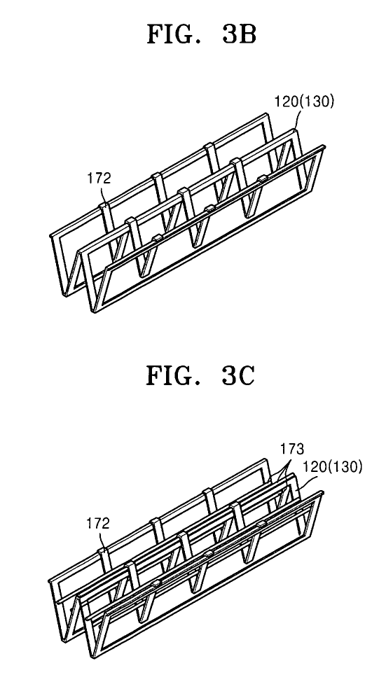

Referring to FIGS. 3A through 3C, the anode frame 120 and/or the cathode frame 130 can further include reinforcing members 171, 172, and 173, to increase the strength of the anode frame 120 and/or the cathode frame 130. Many spaces are formed in the anode frame 120 and the cathode frame 130, so that a fuel and air can respectively contact the anode 111 and the cathode 113. Therefore, the strength of the anode frame 120 and the cathode frame 130 may be reduced by the holes. Thus, the reinforcing members 171, 172, and 173 can be added to the anode frame 120 and/or the cathode frame 130, to support the anode frame 120 and the cathode frame 130, and the unit cells 110. The reinforcing members 171 are V-shaped, the reinforcing members 172 are W-shaped, and the reinforcing members 173 are bar-shaped (refer to FIGS. 3A and 3B). The V-shaped members 171 and/or the W-shaped members 172 are connected by the bar-shaped members 173 (refer to FIG. 3C).

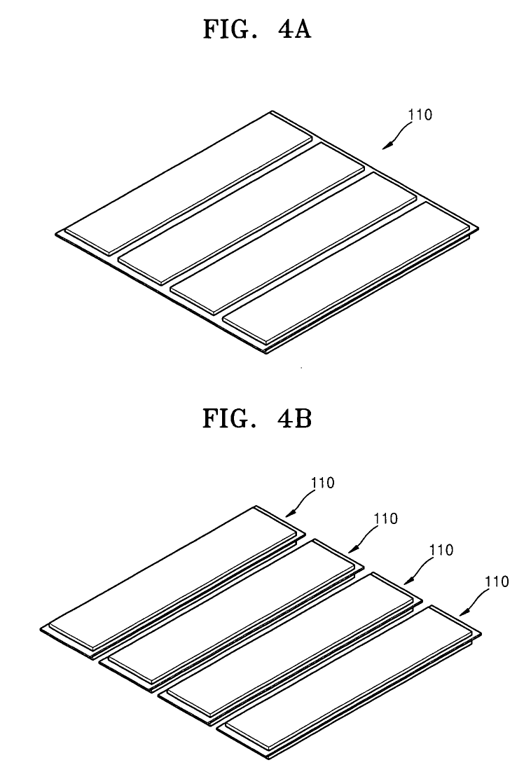

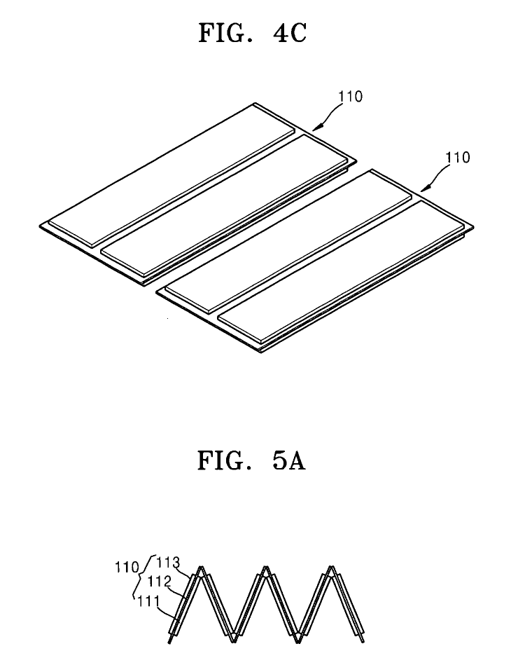

As depicted in FIG. 4A, if a plurality of unit cells 110 are connected in one body, the unit cells 110 are folded into a zigzag pattern. As depicted in FIG. 4B, if the unit cells 110 are not initially connected to one another, each of the unit cells 110 can be attached to one another, by the anode frame 120 and/or the cathode frame 130. As depicted in FIG. 4C, the unit cells 110 can be initially connected in pairs, and then can be installed on the anode frame 120, and/or the cathode frame 130.

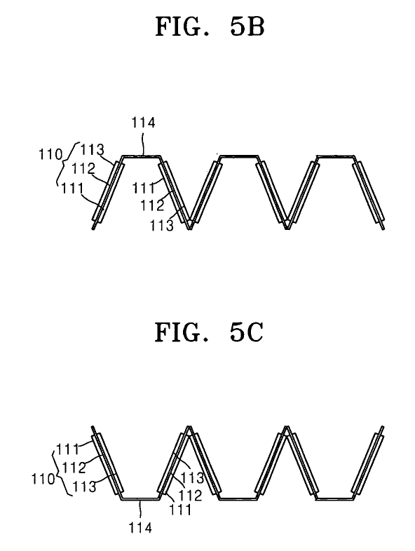

Referring to FIGS. 5A through 5C, the configuration of the unit cells 110 can be modified in various ways. As depicted in FIG. 5A, the unit cells 110 can be installed in a symmetrical zigzag pattern. In this configuration, spaces to supply a fuel and air, to the anode 111 and the cathode 113, are uniform.

In another configuration, as depicted in FIG. 5B, plane units 114 can be formed, such that spaces between adjacent cathodes 113 are smaller than spaces between adjacent anodes 111. In this configuration, a space for vaporizing the fuel is increased below the anodes 111, to facilitate the supply of the fuel to the anode 111.

Also, as depicted in FIG. 5C, the plane units 114 can be formed, such that spaces between adjacent anodes 111 are smaller than spaces between adjacent cathodes 113. In this configuration, a space to supply air to the cathodes 113 is increased, to facilitate the supply of air to the cathode 113. Therefore, if the unit cells 110 are disposed in a zigzag pattern, with an angle θ of between 0° and 180°, a simple and compact fuel cell can be realized.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

What is claimed is:

1. A fuel cell comprising unit cells that comprise an anode and a cathode separated by an electrolyte membrane, wherein the unit cells are stacked together, such that adjacent ones of the unit cells are disposed at an angle of between 0° and 180° with respect to one another.

2. The fuel cell of claim 1, wherein the unit cells are disposed in a zigzag pattern and the adjacent unit cells are each disposed at the same angle.

3. The fuel cell of claim 1, further comprising:
an anode frame that supports an anode side of the unit cells;
a cathode frame that supports a cathode side of the unit cells;
a housing that surrounds the anode frame; and
a fuel supply unit to supply a fuel to the anodes, through a space at least partially defined by the housing.

4. The fuel cell of claim 3, wherein the fuel supply unit comprises:
a fuel storage tank to store the fuel; and
a transportation tube unit to transport the fuel from the fuel storage tank to the space defined by the housing.

5. The fuel cell of claim 4, wherein the transportation tube unit extends through the housing.

6. The fuel cell of claim 4, wherein the transportation tube unit extends through the anode frame.

7. The fuel cell of claim 1, wherein the fuel supply unit further comprises actuators that control the amount of injected fuel of flow channels of the transportation tube unit.

8. The fuel cell of claim 3, further comprising reinforcing members to support at least one of the anode frame and the cathode frame.

9. The fuel cell of claim 3, further comprising end plates disposed on ends of the anode frame, to block the influx of an oxidant into the space of the housing.

10. The fuel cell of claim 1, wherein the unit cells are formed as one unit that is folded to form the angles between the adjacent unit cells.

11. The fuel cell of claim 1, wherein the unit cells are formed as separate units.

12. The fuel cell of claim 1, wherein every other one of the unit cells are parallel to each other.

13. The fuel cell of claim 1, wherein sides of the unit cells are connected to each other by plane units, such that the anodes of the adjacent unit cells are closer to one another than the cathodes of the adjacent unit cells.

14. The fuel cell of claim 1, wherein sides of the unit cells are connected to each other by plane units, such that the cathodes of the adjacent unit cells are closer to one another than the anodes of the adjacent unit cells.
